(19) United States
(12) Patent Application Publication
(10) Pub. No.: US 2012/0270533 A1
(43) Pub. Date: Oct. 25, 2012

(54) MOBILE PHONE AND POINTER CONTROL METHOD THEREOF

(75) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/159,435

(22) Filed: Jun. 14, 2011

(30) Foreign Application Priority Data
Apr. 19, 2011 (CN) 201110097696.0

(51) Int. Cl. G06F 3/033; H04W 88/02

(52) U.S. Cl. 455/420; 455/556.1; 345/157

(57) ABSTRACT

The disclosure provides a mobile phone with pointer and a pointer control method adapted for the mobile phone. When a user finger over a touch screen is within a predetermined distance, a position of the touch screen corresponding to the user finger displays a pointer. When the finger moves over the touch screen within the predetermined distance, the pointer on the touch screen moves with the finger moving. When the user generates an operation on the touch screen and presses/slides the position of the pointer, the mobile phone performs a function corresponding to the operation.

### BACKGROUND

1. Technical Field

The present disclosure relates to mobile phones and particularly, to a mobile phone implementing a pointer control method.

2. Description of Related Art

Mobile phones with a touch screen are convenient for inputting commands, however, the mobile phone does not include a pointer display, if there is a pointer displayed on the touch screen, it is convenient for a user to use the mobile phone.

Therefore, it is necessary to provide a mobile phone and a control method capable of overcoming the limitations described.

### BRIEF DESCRIPTION OF THE DRAWINGS

FIG. 1 is a block diagram of a mobile phone, according to an exemplary embodiment.

FIG. 2 is a flowchart of a pointer control method, according to an exemplary embodiment.

### DETAILED DESCRIPTION

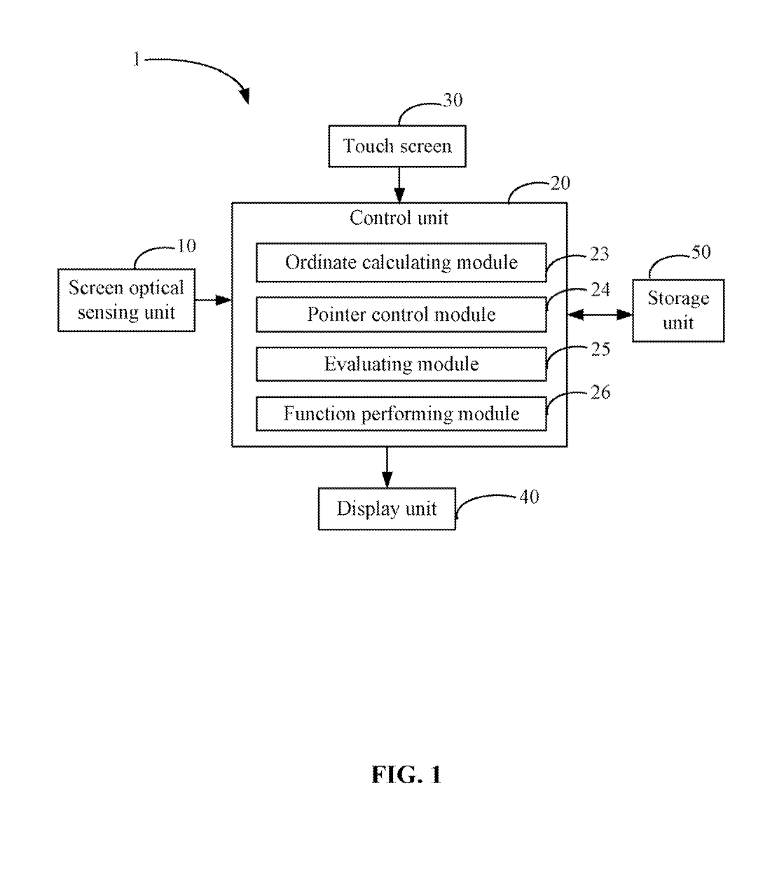

FIG. 1 is a block diagram of a mobile phone, according to an exemplary embodiment. The mobile phone 1 includes a screen optical sensing unit 10, a control unit 20, a touch screen 30, a display unit 40, and a storage unit 50. The screen optical sensing unit 10 is configured for sensing light blocked by a finger on the touch screen 30 in real time and forming a light spot on the touch screen 30 corresponding to the finger to generate a light source signal. That is, the screen optical sensing unit 10 senses whether the light over the touch screen 30 is blocked, which means that a finger is located over the touch screen 30 within a predetermined distance. When a finger over the touch screen 30 is within the predetermined distance, the screen optical sensing unit 10 senses the finger and forms the light spot on the touch screen 30 corresponding to the finger to generate the light source signal. In the embodiment, the screen optical sensing unit 10 is an integrated through screen optical module. The display unit 40 is configured for displaying information. The storage unit 50 is configured for storing position information and direction information on the touch screen 30 and function applications associated with the position or the direction information.

The touch screen 30 is configured for responding to touch operations from the finger, such as a press operation and a sliding operation. The control unit 20 is configured for controlling the mobile phone 1. The control unit 20 includes an ordinate calculating module 23, a pointer control module 24, an evaluating module 25, and a function performing module 26. The ordinate calculating module 23 is configured for calculating coordinates of the light spot and obtaining the position of the light spot on the touch screen 30 according to the light source signal. In the embodiment, the ordinate calculating module 23 processes the light spot and acquires the center of the spot for calculating the coordinates of the light spot. The pointer control module 24 is configured for generating a pointer on the position of the light spot and controlling the display unit 40 to display the pointer on the touch screen 30.

Therefore, when the screen optical sensing unit 10 generates the light source signal in response to a finger within the predetermined distance, the pointer control module 24 controls the display unit 40 to display the pointer on the touch screen 30 corresponding to the finger. When a finger over the touch screen 30 is beyond the predetermined distance, the pointer control module 24 controls the pointer on the touch screen 30 to disappear.

The evaluating module 25 is configured for evaluating whether an operation is received on the pointer position from a finger. When the pointer position receives the operation from a finger, the function performing module 26 is configured for acquiring a function application for the operation on the pointer position from the storage unit 50, and performing a function associated with the function application.

When the evaluating module 25 evaluates that a press operation is received on the pointer position from a finger, the function performing module 26 acquires the position information for the pointer position and a function application associated with the position information for the press operation from the storage unit 50 and performs a function associated with the function application. For example, when a press operation on a phonebook icon is received on the pointer position from a finger, the function performing module 26 performs a function of opening the phonebook.

When the evaluating module 25 evaluates that a plurality of successive light source signals are received in a predetermined time period, the ordinate calculating module 23 calculates an end position of the pointer according to a last light source signal and the pointer control module 24 controls the display unit 40 to display the pointer on the end position, the evaluating module 25 evaluates a sliding direction of a finger according to a start position and the end position of the pointer, and the function performing module 26 acquires a function application according to the sliding direction from the storage unit 50 and performs a function associated with the function application. In the embodiment, the predetermined time period is about 0.1 second. For example, when a finger slides downward a page, the pointer is displayed on the course of the slide, the ordinate calculating module 23 calculates a start position and an end position of the pointer, and the function performing module 26 performs a function of moving the page downward on the display unit 40 according to the sliding direction.

Therefore, when a finger of the user over a touch screen 30 is within the predetermined distance, a position of the touch screen 30 under the finger of the user displays a pointer. When a finger moves over the touch screen 30 within the predetermined distance, the pointer on the touch screen 30 moves with the finger moving. When a finger generates an operation on the touch screen 30 and presses/slides the position of the pointer, the mobile phone 1 performs a function corresponding to the operation.

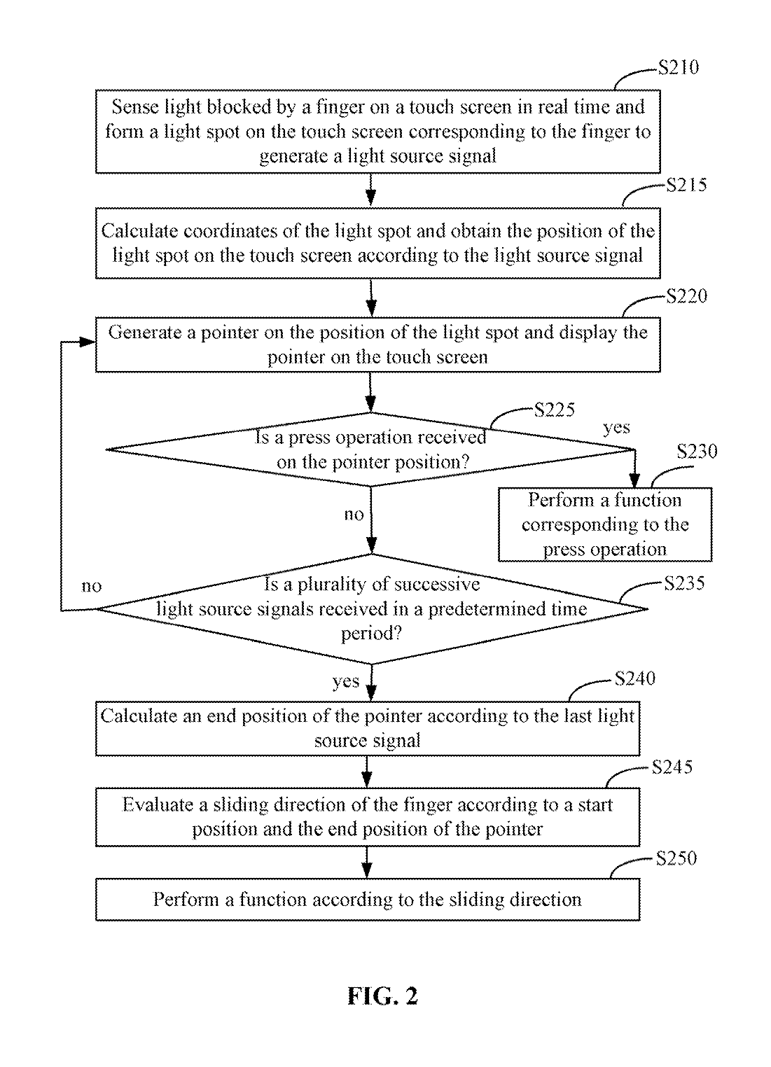

FIG. 2 is a flowchart of a method of controlling a pointer, according to an exemplary embodiment. In step S210, the screen optical sensing unit 10 senses light blocked by a finger on the touch screen 30 in real time, and forms a light spot on the touch screen 30 corresponding to the finger to generate the light source signal. In step S215, the ordinate calculating module 23 calculates coordinates of the light spot and obtains the position of the light spot on the touch screen 30 according to the light source signal. In step S220, the pointer control module 24 generates the pointer on the position of the light spot and controls the display unit 40 to display the pointer on the touch screen 30. In step S225, the evaluating module 25 evaluates whether the press operation is received on the pointer position from the finger. If the press operation is received on the pointer position, in step S230, the function performing module 26 performs the function corresponding to the press operation.

If no, in step S235, the evaluating module 25 evaluates whether a plurality of successive light source signals are received in the predetermined time period. If a plurality of successive light source signals are not received in the predetermined time period, the procedure returns the step S220.

If a plurality of successive light source signals are received in the predetermined time period, in step S240, the ordinate calculating module 23 calculates the end position of the pointer according to the last light source signal. In step S245, the evaluating module 25 evaluates a sliding direction of the finger according to the start position and the end position of the pointer. In step S250, the function performing module 26 performs a function according to the sliding direction.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A mobile phone for controlling a pointer, comprising:
a touch screen;
a storage unit for storing position information and direction information on the touch screen and function applications associated with the position or the direction information;
a display unit;
a screen optical sensing unit for sensing light blocked by a finger on the touch screen in real time and forming a light spot on the touch screen corresponding to the finger to generate a light source signal; and
a control unit for calculating coordinates of the light spot and obtaining the position of the light spot on the touch screen according to the light source signal, generating a pointer on the position of the light spot and displaying the pointer on the touch screen, evaluating whether an operation is received on the pointer position from the finger, when the pointer position receives the operation, acquiring a function application for the operation on the pointer position from the storage unit, and performing a function associated with the function application.

2. The mobile phone as recited in claim 1, wherein the screen optical sensing unit is an integrated through screen optical module.

3. The mobile phone as recited in claim 1, wherein the control unit is further configured for evaluating that a press operation is received on the pointer position from the finger, acquiring the position information for the pointer position and a function application associated with the position information for the press operation from the storage unit, and performing a function associated with the function application.

4. The mobile phone as recited in claim 1, wherein the control unit is further configured for evaluating that a plurality of successive light source signals are received in a predetermined time period, calculating an end position of the pointer according to a last light source signal and displaying the pointer on the end position, evaluating a sliding direction of the finger according to a start position and the end position of the pointer, acquiring a function application according to the sliding direction from the storage unit, and performing a function associated with the function application.

5. The mobile phone as recited in claim 4, wherein the predetermined time period is about 0.1 second.

6. The mobile phone as recited in claim 1, wherein the control unit is further configured for processing the light spot and acquiring the center of the spot for calculating the coordinates of the light spot.

7. A method for controlling a pointer by a mobile phone, wherein the mobile phone comprises a touch screen and stores position information and direction information on the touch screen and function applications associated with the position or the direction information, the method comprising:
sensing light blocked by a finger on the touch screen in real time and forming a light spot on the touch screen corresponding to the finger to generate a light source signal;
calculating coordinates of the light spot and obtaining the position of the light spot on the touch screen according to the light source signal;
generating a pointer on the position of the light spot and displaying the pointer on the touch screen;
evaluating whether an operation is received on the pointer position from the finger; and
if the pointer position receives the operation, acquiring a function application for the operation on the pointer position and performing a function associated with the function application.

8. The method as recited in claim 7, further comprising:
evaluating that a press operation is received on the pointer position from the finger, acquiring the position information for the pointer position and a function application associated with the position information for the press operation, and performing a function associated with the function application.

9. The method as recited in claim 7, further comprising:
evaluating that a plurality of successive light source signals are received in a predetermined time period, calculating an end position of the pointer according to a last light source signal, and displaying the pointer on the end position;
evaluating a sliding direction of the finger according to a start position and the end position of the pointer; and
acquiring a function application according to the sliding direction and performing a function associated with the function application.

10. The method as recited in claim 9, wherein the predetermined time period is about 0.1 second.

11. The method as recited in claim 7, further comprising:
processing the light spot and acquiring the center of the spot for calculating the coordinates of the light spot.
